(19) United States
(12) Patent Application Publication
(10) Pub. No.: US 2014/0164382 A1
(43) Pub. Date: Jun. 12, 2014

(54) System and Method for Managing Online Dynamic Content

(71) Applicant: Jonathan Keebler, Toronto (CA)

(72) Inventor: Jonathan Keebler, Toronto (CA)

(73) Assignee: SCRIBBLE TECHNOLOGIES INC., Toronto (CA)

(21) Appl. No.: 14/123,583

(22) PCT Filed: Jul. 18, 2011
(86) PCT No.: PCT/US11/01263

§ 371 Date: Dec. 3, 2013

(51) Int. Cl. G06F 17/30

(52) U.S. Cl. CPC G06F 17/3089
USPC 707/737

(57) ABSTRACT

Methods and systems for managing and publishing online dynamic content. Content can be generated or managed at a publishing server. Content at the publishing server is periodically polled for additions, changes or deletions. Modifications are transmitted to a storage system, which may be further transmitted to a content distribution network, for delivery to a client.

### FIELD

The described embodiments relate to methods and systems for managing online digital content and in particular to methods and systems for generating, modifying, updating and publishing content, as well as receiving published and modified content.

### BACKGROUND

Online publishers often employ a content management system (CMS) to manage workflows and publishing of news and entertainment content in a collaborative environment. Often, content such as text articles and multimedia presentations may be prepared and edited ahead of publication. Accordingly, a CMS enables publishers to establish a multi-tiered process for creation and revision of content prior to publication, such that quality and editorial control can be maintained.

Although a CMS may be beneficial in conventional online publishing, where content is prepared prior to publication, in some contexts the multi-tiered approach of traditional content management systems may hinder rapid dissemination of information. In one example, in a live reporting scenario, an online publisher may wish to allow authorized individuals to directly report news regarding a current event, bypassing editorial procedures. In another example, an online publisher may wish to encourage audience participation, by soliciting real-time comments and feedback in response to a live discussion. However, while conventional CMS systems might be adaptable to provide such features, frequent updating may require significant computing and bandwidth resources. One reason for this is that conventional CMS systems typically publish complete pages, which results in considerable redundancy when the complete page is repeatedly transferred to a client that is requesting frequent updates.

There is a need for an improved system and method for managing online content that is dynamically changing in real-time.

### SUMMARY

In a first aspect, there is provided a method of managing online content wherein the content comprises a data collection identified in a database having one or more data items associated therewith. The method may comprise periodically polling the database to identify at least one modification of the one or more data items; if the polling identifies the at least one modification, generating, using a processor, a modification representation associated with the data collection, the modification representation identifying the at least one modification of the one or more data items; and storing the modification representation.

In some cases, the one or more data items are also associated with a second data collection, and the method further comprises, if the polling identifies the at least one modification, generating, using the processor, a second modification representation associated with the second data collection, the second modification representation identifying the at least one modification of the one or more data items; and storing the second modification representation.

The method may further comprise, if the polling identifies the at least one modification, generating at least one indication that the at least one modification has occurred. The method may further comprise transmitting the at least one indication to a server. In some cases, the at least one indication is a file comprising a unique identifier. The unique identifier may be a timestamp.

In some cases, the modification representation identifies only modifications that occurred within a predetermined interval window. In some cases, the modification representation comprises data for recreating the at least one modification.

In some cases, the at least one modification may comprise an addition of a data item to the one or more data items, a deletion of a data item from the one or more data items, or a change to a data item in the one or more data items.

Storing the modification representation may comprise transmitting the modification representation to a server.

The method may further comprise, prior to generating the modification representation, receiving input data; processing the input data to generate the one or more data items; and associating the one or more data items with the data collection in a database. The method may further comprise transmitting an initial representation of the one or more data items to a server, and/or associating a template with the data collection.

In some cases, the polling occurs asynchronously to the generating the modification representation, or asynchronously to the storing the modification representation.

In some cases, the server is part of a content distribution network.

In another broad aspect, there is provided a method of updating one or more data items at a client device, the one or more data items associated with content for an online publication wherein the content comprises a data collection identified in a database. The method may comprise receiving an initial representation of the one or more data items from a server; displaying an output based on the initial representation; receiving a modification representation, the modification representation identifying at least one modification of the one or more data items; generating, using a processor of the client device, a current representation of the one or more data items based on the initial representation and the modification representation; and updating the output based on the current representation.

The method may further comprise, prior to receiving the modification representation, periodically polling for an indication that the at least one modification has occurred and, if the indication indicates that the at least one modification has occurred, then receiving the modification representation.

In some cases, the modification representation comprises data for recreating the at least one modification.

In some cases, the at least one modification may comprise an addition of a data item to the one or more data items, a deletion of a data item from the one or more data items, or a change to a data item in the one or more data items.

In some cases, the initial representation comprises computer-executable instructions for causing the processor to perform the periodic polling and the receiving the modification representation.

The method may further comprise, if a number of the data items to be displayed in the current representation exceeds a predetermined limit of data items, paginating the current representation.

In some cases, paginating the current representation comprises subdividing the one or more data items into two or more groups of data items and displaying only a most recent group of data items, and wherein each of the groups is sized according to the predetermined limit of data items. Each of the groups may have a unique URL. The URLs for each of two or more groups of data items may be displayed in reverse chronological order when live and displayed in forward chronological order when not live. Paginating may be delayed until the number of data items displayed in the current representation exceeds the predetermined limit of data items by a predetermined threshold. The predetermined threshold may be 20%.

The method may further comprise, prior to displaying the output, receiving a template from a template server, wherein the initial representation and the current representation are generated based also on the template. The template may be associated with the data collection in the database. The template may comprise a content marker, and the method may further comprise identifying a location of the content marker in the template, wherein the current representation can be generated by modifying the template to display the one or more data items substantially at the location of the content marker.

In another broad aspect, there is provided a method of generating content in response to a client request, the content comprising a one or more data items associated with a data collection. The method may comprise determining if a current template associated with the data collection exists; if the current template exists, generating an initial representation of the data collection based on the template; determining if the current template should be updated; and if the current template should be updated, initiating a template update comprising: requesting a new template from a template server; verifying the new template; and if the verifying is successful, updating the current template based on the new template.

In some cases, the template update is initiated in a new thread or process. In some cases, the verifying comprises identifying a content marker in the new template.

In another broad aspect, there is provided a system for scalable publishing of online content. The system may comprise a database, the database for identifying a data collection having one or more data items associated therewith; a publishing server, the publishing server configured to identify modifications to the data collection; a storage system for storing the data collection; a content management module, the content management module configured to determine that the modifications to the data collection have been identified and to transmit the modifications to the data collection to the storage system; and a content distribution network for caching and delivering the data collection.

In another broad aspect, there is provided a system for scalable publishing of online content. The system may comprise a database, the database for identifying a data collection having one or more data items associated therewith; a publishing server; a storage system; a content management module, the content management module configured to: periodically poll the database to identify at least one modification of the one or more data items; if the polling identifies the at least one modification, generate a modification representation associated with the data collection, the modification representation identifying the at least one modification of the one or more data items; and transmit an indication of the modification representation to the storage system; and a content distribution network for caching and delivering the data collection stored at the storage system.

In another broad aspect, there is provided a method of dynamic templating for online content wherein the content comprises a data collection identified in a database having one or more data items associated therewith. The method may comprise determining that a current template object is to be updated; requesting a new template object from a third-party server; receiving the new template object from the third-party server; processing, using a processor, the new template object to determine a content location in the new template object; updating the current template object based on the new template object after processing; and generating the online content using the data collection and the current template object as updated.

In another broad aspect, there is provided a method of publishing online content wherein the content comprises a data collection identified in a database having one or more data items associated therewith. The method may comprise storing a list of one or more publication targets; receiving a selection of publication targets from the one or more publication targets; determining one or more template objects associated with the selection of publication targets; generating a publication object, based on the data collection, for each of the selection of publication targets, formatting the publication object based on the associated template object and transmitting the publication object to a location associated with a respective publication target.

### BRIEF DESCRIPTION OF THE DRAWINGS

A preferred embodiment of the present invention will now be described in detail with reference to the drawings, in which:

FIG. 1 illustrates a simplified schematic diagram of an exemplary content publishing system;

FIG. 2 illustrates a block diagram of modules in an exemplary dynamic publishing server, such as that of FIG. 1;

FIG. 3 illustrates a process flow diagram for creating an exemplary publication object;

FIG. 4 illustrates an exemplary user interface for submitting input data;

FIG. 5 illustrates an exemplary content input process flow;

FIG. 6 illustrates an exemplary update process flow;

FIG. 7 illustrates an exemplary template generation process flow;

FIG. 8 illustrates an exemplary display process flow;

FIG. 9 illustrates an exemplary publication object;

FIG. 10 illustrates another exemplary publication object; and

FIG. 11 illustrates yet another exemplary publication object.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF EXEMPLARY EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. For example and without limitation, the programmable computers may be a server, network appliance, set-top box, embedded device, computer expansion module, personal computer, laptop, personal data assistant, or mobile device. Program code is applied to data to perform the functions described herein and generate output. The output is applied to one or more output devices as described herein, or in known fashion. In some embodiments, the communication interface may be a network communication interface. In embodiments where elements of the invention are combined, the communication interface may be a software communication interface, such as those for inter-process communication (IPC). In still other embodiments, there may be a combination of communication interfaces.

Each program is preferably implemented in a high level procedural or object oriented programming and/or scripting language to communicate with a computer system. However, the programs can be implemented in assembly or machine language, if desired. In any case, the language may be a compiled or interpreted language.

The systems, processes and methods of the described embodiments are capable of being distributed in a computer program product comprising a non-transitory computer readable medium that bears computer usable instructions for one or more processors. The medium may be provided in various forms, including one or more diskettes, compact disks, tapes, chips, magnetic and electronic storage media, and the like. The systems, processes and methods of the described embodiments may also be provided using a Software-as-a-Service (SaaS) model. The computer useable instructions may also be in various forms, including compiled and non-compiled code.

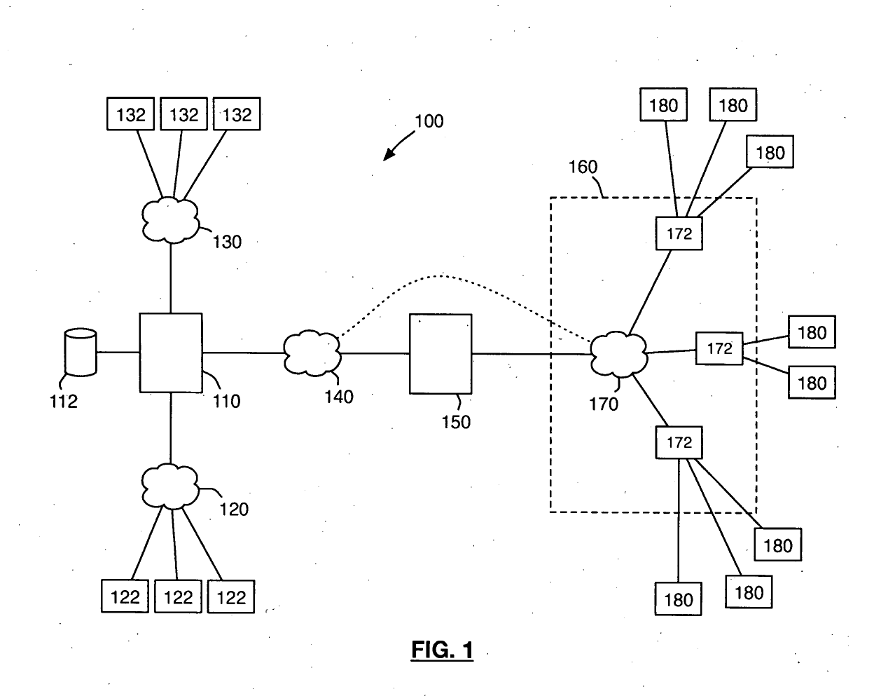

Reference is first made to FIG. 1, in which there is shown a simplified schematic diagram of an exemplary content publishing system.

Content publishing system 100 comprises a dynamic publishing server 110, which may comprise a database 112. Content publishing system 100 can be configured to publish digital content (e.g., a publication object comprising one or more data collections), which can be retrieved by clients and assembled into complete pages.

A data collection can comprise one or more data items. In some cases, a data collection may comprise one or more other data collections, in addition to other data items. In the context of dynamic content, the data items in a data collection may be modified in real time. In particular, new data items may be added to the data collection and existing data items in the data collection may be changed or deleted.

In general, a data collection may comprise any reference to one or more data items. In some cases, the reference may be one or more specific references, and individual data items in the data collection may be identified with indices, tokens, tags or other suitable identifiers.

For example, a unique index can provide an address to facilitate look-ups for a particular data item. An index may be one or more attributes used to identify the object, a hash value, or a unique token, such as a series of reference characters, that can be used to directly or indirectly identify the data item. An index may include different kinds of values depending on the data item, such as a token for one data item and a positional value for another data item. The index for a data item may also include multiple values, such as both a token and a positional value for one data item. A positional value may be defined as in relation to other data items.

The data collection may also comprise one or more references in the form of a search query comprising one or more keywords, where the keywords may serve to identify data items relating to a particular event, topic, keyword or other grouping mechanism. Each of the data items identified via a search query may still have an identifier (e.g., index, token, tag, etc.).

The data collection may also comprise additional properties or metadata, as described herein.

In some embodiments, the data collection may be provided as a block of HTML content.

Individual data items may comprise characters and text (e.g., captions, tags, prose, etc.), images, audio and video content. In some cases, data items may also comprise executable instructions (e.g., JavaScript). In some cases, data items may provide a reference identifier for a specific content file.

For the purposes of exposition, the terms ‘content’ and ‘data collection’ may be used interchangeably herein.

Dynamic publishing server 110 may provide frequent updates to a publication object without the resource burden that might be incurred by a conventional CMS. A publication object can comprise one or more data collections and their associated data items, and may take the form of HTML content, including formatting and scripts. In some cases, a publication object may form the entire contents of a web page.

Publication objects may be contrasted with publication targets. Publication targets can be a specific web page, a web site directory, an embeddable object such as a Flash™ object, or the like.

In general, a publication target is the location that a publication object is, or will be, published. Accordingly, if the publication object is a complete web page, the publication target may be a web site directory. Conversely, if the publication object is a block of HTML content, the publication target may be a portion of a specific web page where the block of HTML content is to be inserted or embedded.

Dynamic publishing server 110 may be connected to one or more networks 120, 130 and 140. In some cases, networks 120, 130 or 140 may form parts of a single larger network, such as the Internet, or may be selectively interconnected with each other. One or more of networks 120, 130 or 140 may be a wired or wireless local area network, a wide area network, a virtual private network, a mobile data network or other suitable network for facilitating data communication.

One or more input devices 122 communicate directly or indirectly with dynamic publishing server 110 via network 120. Input devices 122, which may also be referred to as client devices or writer devices, may be communication or computing devices, such as desktop or laptop computers, mobile devices, telephones and the like. In some cases, input devices 122 may be additional content publishing systems 100, which can be federated.

In some cases, dynamic publishing server 110 may have a local input device 122, which can be an alternative input interface. For example, dynamic publishing server 110 may have a telephony (including VOIP) or voicemail system for recording voice messages, or may integrate with such a system. Accordingly, voice messages may be used as input, or transcribed and used as input. Subsequently, the voice messages may be published in audio form, or transcribed and published in written form. Such features may be beneficial in situations where access to the dynamic publishing server 110 by data communication means is impractical or otherwise restricted (e.g., due to Internet faults or censorship).

In some cases, an input device 122 may be configured to extend services to one or more additional input devices. For example, an input device 122 may aggregate input data from one or more additional input devices that are on a local network, and transmit the aggregated data to dynamic publishing server 110.

Similarly, one or more publishing partners 132 may be connected to dynamic publishing server 110 via network 130. Publishing partners 132 may be content publishing servers or services, such as public or private web sites, content management systems and the like. Examples of publishing partners 132 include news and entertainment publishing organizations, news aggregators, photo sharing websites, social networks, and other content providers. In general, any party that creates or manages a publication object, or which provides a data collection, may be considered a publishing partner 132. Accordingly, freelance journalists, photographers and the like may also be publishing partners 132. In some cases, input devices 122 may also be considered publishing partners 132.

In some cases, publishing partners 132 may include telephony (including voice over IP) services. Accordingly, published content may be in, or converted to, audio form. Likewise, input content may be received in, or converted to, audio form.

It will be appreciated that dynamic publishing server 110 may also comprise one or more primary servers and one or more caching servers, to reduce processing load on the primary servers. For example, dynamic publishing server 110 may comprise a server dedicated to one or more publishing partners 132.

Optionally, dynamic publishing server 110 may be connected to storage system 150 via network 140. Storage system 150 can be configured to store or distribute content over the Internet, or the World-Wide Web in particular, in a scalable manner. In particular, storage system 150 can be a cloud-based web storage and retrieval system, such as Amazon™ Simple Storage Service (S3).

Storage system 150 can be a caching server, a distributed storage system, a storage service, a content distribution network or content delivery network (CDN), reverse proxy, or the like.

Dynamic publishing server 110 or, optionally, storage system 150 can be connected to a CDN 160. CDN 160 can be a specialized distribution network adapted to synchronize and distribute content to a plurality of geographically distributed edge nodes, to facilitate scalable, high availability and low latency delivery to a large number of end users.

CDN 160 may comprise a core network 170 for interconnection with a plurality of edge nodes 172. The internal structure of CDN 160 may be structured in a tiered or other fashion, as will be appreciated by those skilled in the art.

A plurality of clients 180 can connect to CDN 160. In general, CDN 160 is configured to identify the edge node 172 that is nearest, or which can provide, the best quality of service, to a particular client 180.

By utilizing CDN 160 and storage system 150, dynamic publishing server 110 can be insulated from the effects of high demand for services from end user clients. Likewise, dynamic publishing server 110 can be designed to provide scalability, high availability and low latency delivery independently of the number of end user clients. In particular, the bandwidth requirement for dynamic publishing server 110 can be dependent simply on the amount of content being published. Likewise, by using CDN 160 and/or storage system 150, dynamic publisher server 110 can serve a large number of clients without the corresponding requirement to open a large number of sockets, service a large number of requests per second, and the like. In contrast, storage system 150 and CDN 160 can distribute content to a large number of end user clients and can be scaled to respond to large fluctuations in demand.

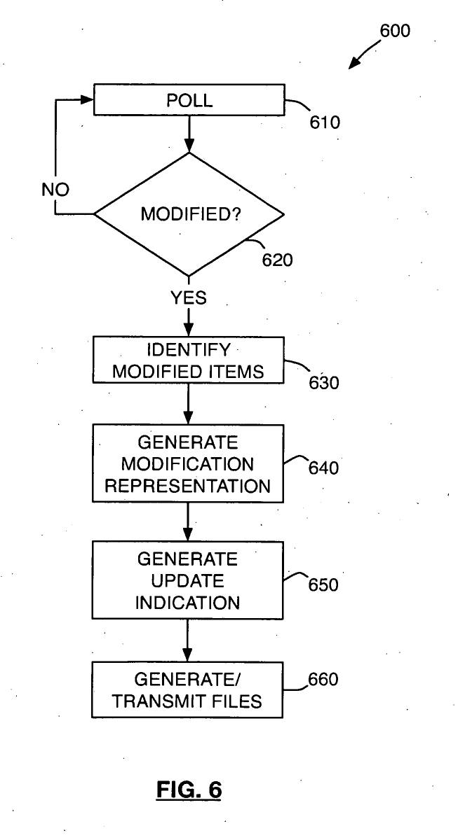

When a data collection is updated with new or changed data items, or a data item is deleted, dynamic publishing server 110 may transmit a modification representation corresponding to the data collection, once, to storage system 150 or CDN 160, whereupon storage system 150 or CDN 160 can distribute to a large number of users, according to their respective designs. Publication of content is described in further detail herein, for example with reference to FIG. 6.

For ease of reference, the functionality of dynamic publishing server 110, storage system 150 and CDN 160 are described herein as being provided by separate servers. However, the functionality of one or both of storage system 150 and CDN 160 may be integrated into dynamic publishing server 110, or omitted entirely. Likewise, storage system 150 may be configured to provide some or all of the functionality of CDN 160, and vice versa. For example, storage system 150 may employ the Amazon™ S3 service to provide scalability, high availability, and low latency delivery.

Content publishing system 100 may be adapted to publish content in real-time. In particular, content publishing system 100 may publish publication objects containing data collections comprising one or more data items. The data collections may comprises data items that are associated chronologically, by topic or otherwise. For example, the data collections may relate to a live content stream, a live question & answer session, a live interview, updates on a current event, and the like. Alternatively, the content published in real-time may take the form of a rapidly changing news article or other non-chronological data format (e.g., an article with real-time updates).

In some cases, content publishing system 100 may also be adapted to publish other content, such as advertisements, pre-written content or other static content.

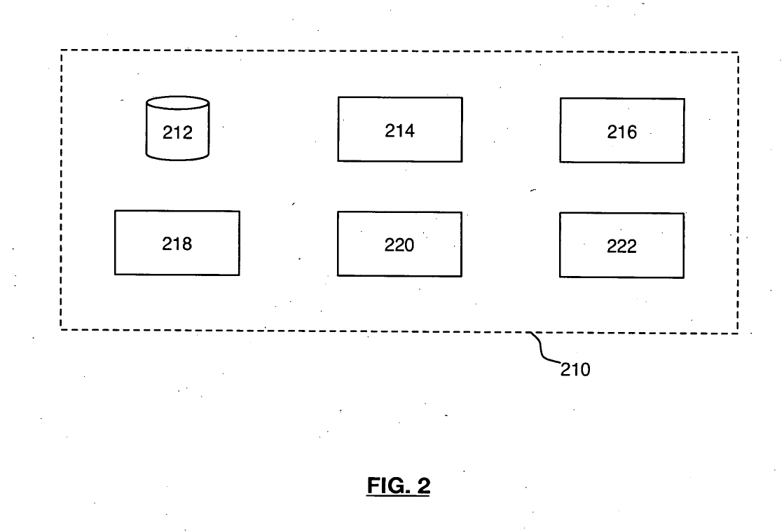

Referring now to FIG. 2, there is shown a block diagram of modules comprised in an exemplary dynamic publishing server. Dynamic publishing server 210, which may be the same or similar to dynamic publishing server 110, can comprise a database 212, a permission module 214, a content input module 216, a template module 218, a content management module 220 and a publication module 222.

Database 212 may comprise one or more relational databases (e.g., SQL) or, in some cases, a flat file database (e.g., NoSQL). Database 212 may be used to store data used by dynamic publishing server 210, including accounts and permission data for users, writers and administrators, template data, data referring to, publication objects, data collections, data items, and other data.

Permission module 214 may be used to store and manage system permissions relating to providing content to dynamic publishing server 210, such as permissions associated with a user computer (e.g., permissions associated with users, commenters and administrators). Permission module 214 may also be used to store and manage system permissions associated with data collections and publication objects, such as, for example, publication times for a publication object. In general, permission module 214 may operate in similar fashion as the permissions system of other content management systems (CMS), in which writers, administrators, commenters and end users are provided with varying degrees of access according to security considerations and content accessibility needs.

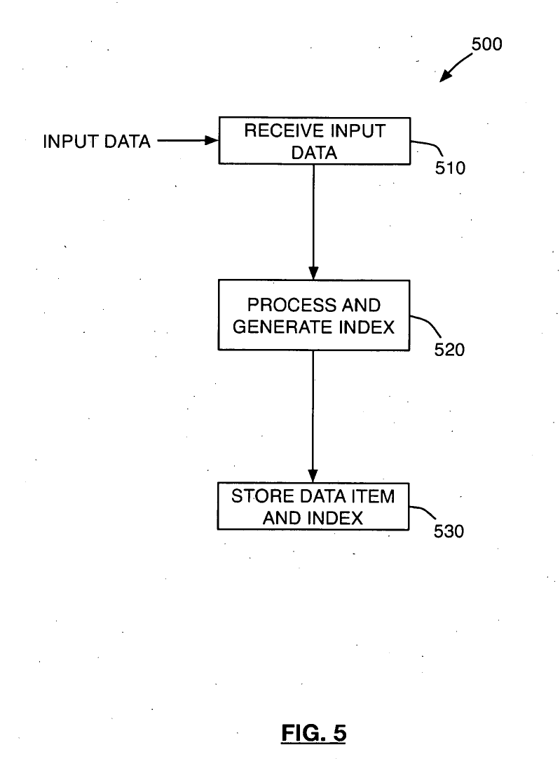

Content input module 216 may be used to manage the reception of input data for processing and generation of data items by dynamic publishing server 210. Operation of content input module 216 is described in further detail herein, for example with reference to FIG. 5.

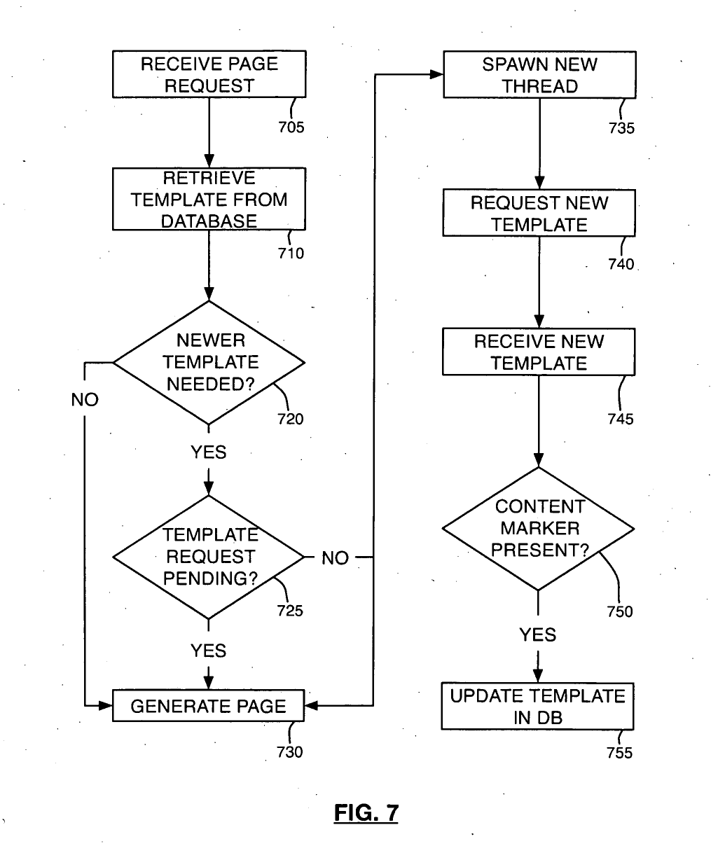

Template module 218 may be used to manage the retrieval and processing of publication templates by dynamic publishing server 210. Operation of template module 218 is described in further detail herein, for example with reference to FIG. 7.

Content management module 220 may be used to process data items for publication, such as those data items generated by content input module 216. Operation of content management module 220 is described in further detail herein, for example with reference to FIG. 6.

Publication module 222 may be used to create and configure a publication object, for the publication of one or more data items associated with a data collection. For example, publication module 222 may be used to identify a data collection (and the associated one or more data items) and create and configure a publication target for publishing the one or more data items. As noted, a publication target can be a specific web page, a web site directory, an embeddable object such as a Flash™ object, or the like.

In one example, a publication target can be a web page that will contain a publication object created for a live event. Ongoing updates may be provided by one or more writers in the form of input data, which can be used to generate modified (including new or updated) data items, and which may be associated with one or more data collections (in turn associated with the publication object created for the live event). Accordingly, publication module 222 may be configured to process and publish the data items in a suitable manner via the publication targets.

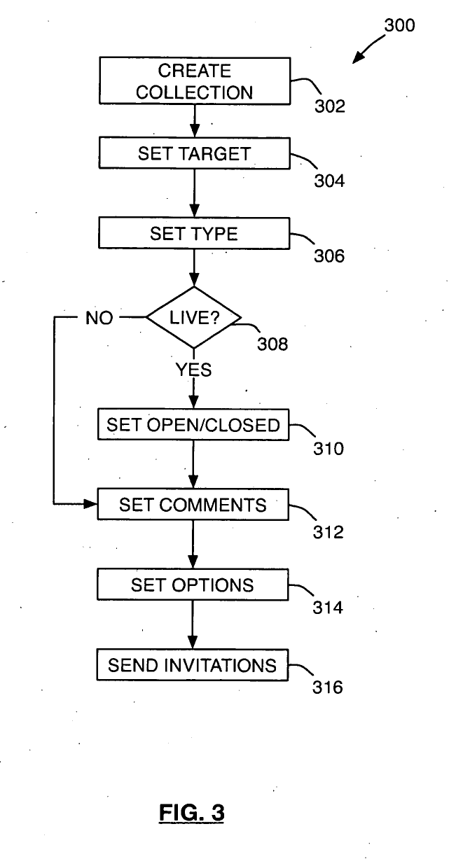

Referring now to FIG. 3, there is shown a process flow diagram for creating an exemplary publication object, which may be performed by publication module 222. Each publication object can have one or more associated data collections.

Creation process 300 begins by creating a new data collection at 302. For example, the data collection may be created by generating a new data collection entry in a database, such as database 212. However, in some cases, a data collection need not be created in the database. For example, the data collection may comprise one or more rules for identifying associated content such as social network posts containing one or more query terms, posts from the same geographic area (e.g., based on geographically-identifying data associated with the post), and posts in the same language.

One or more publication targets can be configured at 304. As described, a publication target may be a web page, a web site, an embeddable object such as a Flash™ object, or the like. Each publication target can be preconfigured by an administrator and may be displayed to a user, for example, as a descriptive name, a domain, a subdomain, a URL or some portion of a URL (e.g., shortened path name or file name). Each publication target may have one or more user-selectable template objects associated therewith.

Template objects may be received from template servers, which may be websites belonging to third parties associated with particular publication targets, and processed to generate a template for publishing a publication object (and its data collections and associated data items). For example, if a publication target is live.example.com, another website at www.example.com may be the template server. Accordingly, a template may be retrieved from, for example, www.example.com/template.html and data items published at the publication target of live.example.com may be formatted based on the retrieved template.

Each publication object may have one or more publication targets. Accordingly, each publication object may be published to one or more locations and, if the publication targets have different templates, the publication object may be formatted differently, depending on the publication target.

A publication object may be prepared in advance in anticipation of publication at a later time, for example by identifying a known data collection (e.g., a search query). In some cases, the data collection may be associated with a “live event”, in which case it may be used to aggregate, in real time, content relating to a specific topic (e.g., submitted by users viewing one or more web pages). Examples of such live events include, for example, reporting news on a current event, a live question & answer session with a person of interest, and the like. Optionally, at 306, the publication type of the publication object may be selected. The publication type may be set to “live”, “dynamic search”, or some other value as may be appropriate.

The publication time for the publication object may also be configured. The publication time may be immediate, deferred until a predetermined future time (e.g., if the data collection is in a draft or prepublication state), or it may indicate that the publication object should not be published at all (e.g., if its data collection relates to system messages, private metadata, or the like).

If the publication type indicates that the object relates, for example, to a live event, and a determination is made that the object relates to a live event at 308, a start and end time of the publication may be chosen. The start time indicates when the scheduled event will begin and the live event is considered “open”. Conversely, the end time indicates when the scheduled event will end and the event is considered “closed”. The “open” or “closed” state of the event may be used to control other features, such as commenting, or to alter the appearance of the published data items. For example, when an event is “open”, published data items may appear in reverse chronological order, such that newly-added data items appear above older data items. Correspondingly, when an event is “closed”, data items may appear in chronological order, for ease of reading.

Alternatively, the start and end time of the publication object may be used to determine if the data collection relates to a live event. For example, if the current time is between the start time and the end time, the publication object may be considered “live” and the data items associated with the data collection may be published accordingly.

Alternatively, or in addition to 310, the publication object may be manually configured by an administrative user to specify that the object is “open” or “closed”, at 312. In such cases, start and end times may be optional and not configured. In some cases, the publication object may be configured to automatically become “closed”, for example after a predetermined period has passed without any activity.

If the publication type is not a live event, the process may proceed directly to configuration of user commenting at 312. If user commenting is enabled for a publication object, end users viewing the data collection (e.g., at a publication target) may be enabled to submit comments regarding the data collection. In some cases, commenters may also submit content via external sources, such as e-mail, Twitter™, Facebook™ and the like. However, some templates may prevent user commenting in certain cases, even if user commenting is enabled.

User comments may be input data that is submitted by third party end users, and which may be used to create additional user-generated data items associated with the data collection. In some cases, user-generated data items originating from the user comments may simply be aggregated with other data items originating from writer devices (e.g., input devices 122) and other authorized users (e.g., those that are already registered with the dynamic publishing system). The user-generated data items may be distinguished from writer-generated data items using a distinct visual or audible presentation, such as a different color scheme or the like.

In some cases, a live query may be configured to generate user comments based on external content, such as e-mail, Twitter and the like.

In some other cases, user-generated data items may be held for approval by a writer or administrator. The writer or administrator may approve certain of the user-generated data items, which may then be published.

In some cases; writer-generated data items may be processed in the same manner as user-generated data items, and vice versa.

In cases where user-generated data items can be held for approval, there may be a delay between the submission of the held user comment and the approval and actual publication of the data item. In a chat or question & answer type live event, such delay may result in confusing and disorderly presentation of the data items to the end user.

In some cases, to maintain continuity and orderly presentation, user-generated data items may be placed in a comment collection and associated with other data items for publication substantially contemporaneously (e.g., in a desired order). In some cases, the comment collection may be modeled as a queue. Accordingly, continuity and ease of reading can be facilitated. However, in other cases, the comment collection need not be ordered by date or time.

At 314, other options associated with the publication object can be configured. Additional options include: a description; a header image; a game id; a language setting; HTML code; event location; time zone; profanity and objectionable language filtering; spam filtering; live language translation; user or Internet Protocol (IP) address filtering; writer and/or commenter e-mail addresses (e.g., for submitting data items directly via e-mail); and Short Message Service (SMS) short codes or phone numbers (e.g., for submitting data items directly via phone).

In some cases, the data collection may comprise one or more external queries. External queries can be search terms or external sources, from which data items can be obtained. Data items may be obtainable, in some cases, only when the data collection is “open”. However, in other cases, data items may also be pulled when the data collection is “closed”. An external query may specify a search term for use on an external social network, such as Twitter™ or Facebook™. For example, content published on the external website twitter.com containing the desired “hashtag” and published while the data collection is “open” can be retrieved and used as a data item. The external data items may be treated as distinct from writer-generated data items and/or user-generated data items.

Similarly, external queries can be links to a specific external source. For example, an external query may identify a specific user or group on a photo sharing website. Accordingly, content uploaded to the photo sharing website while the data collection is “open” can be retrieved and used as a data item.

As described, dynamic publishing server 210 may provide a list of template objects and publication targets, which may be associated with one or more external sites or subdomains. A user configuring a publication object may elect to associate its data collection with one or more publication targets.

In one example, a publication target may be live.example.com, which can be hosted by storage system 150. The site live.example.com may be affiliated with www.example.com, which may have a standard content presentation style. Accordingly, www.example.com may be used as a template server. In some cases, one or more template pages may be prearranged, as is described herein.

Alternatively, a subdirectory www.example.com/live may be provided for hosting publication objects generated by dynamic publishing server 210. For example, the contents of the “live” directory may be hosted by storage system 150 or CDN 160 and dynamic publishing server 210 may be configured to transmit the required content (e.g., data items associated with a data collection in the publication object) to storage system 150 or CDN 160.

Accordingly, when a search engine indexes content belonging to example.com, the content (including any publication objects) provided at live.example.com will appear as though it is published by the publisher of www.example.com, since both live.example.com and www.example.com belong to the same domain example.com. This may have advantages for content indexing and search engine optimization purposes. When the publication object is published, dynamic publishing server 210 may publish several versions, corresponding to each of the selected publication targets. Accordingly, the publication object may appear to be published in several locations, perhaps by several parties.

Optionally, at 316, invitations to contribute input data to be used in the data collection created at 302 may be generated and transmitted. For example, a list of e-mail addresses may be collected and an e-mail invitation containing login information, a registration link or the like may be sent to the provided e-mail addresses. Recipients of the e-mail invitations can use the provided login information or registration link to access a user interface for submitting input data.

In some cases, predetermined users (e.g., identified by e-mail address, phone number, or other identifiers) may be preconfigured with access to contribute input data to create data items for the data collection created at 302.

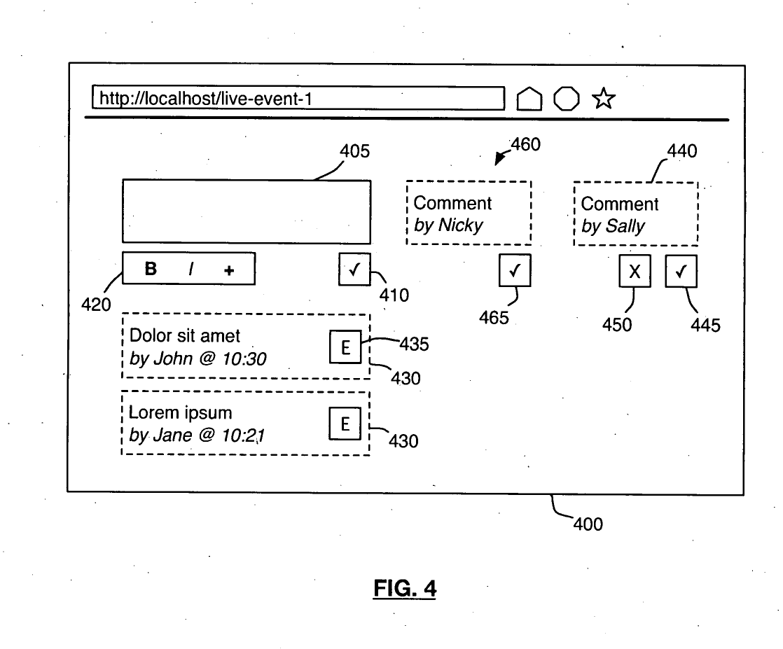

Referring now to FIG. 4, there is shown an exemplary user interface 400 for submitting input data. User interface 400 may be provided, for example, in an HTML document, rendered and provided by a web browser on a client computer.

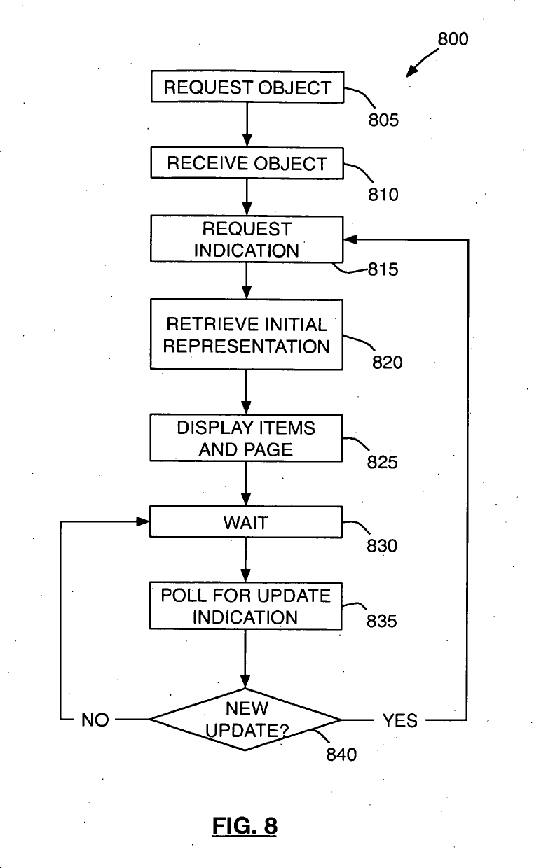

A content input box 405 may be provided, for enabling a user to enter content as part of the input data to be submitted. A submission button 410 can be used to transmit the input data contained in content input box 405, whereupon the input data can be processed to generate a data item corresponding to the input data. In some cases, the data item may be published immediately and the web browser may be configured to retrieve and display the newly-published data item along with previously published data items 430, as described further herein, for example with reference to FIG. 8.

Previously published data items 430 may also be editable upon selecting an appropriate edit control 435. Further controls (not shown in FIG. 4) may also be provided to otherwise manipulate previously published data items (e.g., delete, “sticky”, reply, etc.). In some cases, data items 430 may be directly editable without first selecting an edit control.

If other users are also editing data items and submitting input data in respective user interfaces 400, each of their previously published data items 430 may also be updated in real-time to reflect new data items submitted by other users, as described in U.S. Provisional Application No. 61/449,540, filed Mar. 4, 2011, the entire content of which is hereby incorporated by reference. In general, the display of individual data items 430 may correspond with the view of a data collection that is provided to certain users or administrators depending on their permission level.

Data collection updating and synchronization is described in further detail herein, for example with reference to FIG. 6.

Input data and data items may contain multimedia content. Accordingly, controls 420 can be provided to enable access to additional editing and multimedia sharing features. For example, controls 420 may enable formatting entered text (e.g., to alter type face) or uploading multimedia files including images, audio and video to include as part of the data item. A URL control (not shown) may be provided for submitting URLs to incorporate in the data item. In some cases, URLs entered in content input box 405 may be interpreted and the content at the URL (or a representation or variation), which may include interactive or streaming elements such as video, may be retrieved, linked, or referenced for inclusion in the data item.

Various alternative or complementary content input interfaces and features may be employed, such as a dedicated native client software program, an application programming interface (API) and the like.

In some cases, a webcam or audio recording control (not shown) may be provided to facilitate the capture of live video or audio for inclusion in the data item.

If commenting is enabled, comment moderation controls may also be displayed to users with appropriate permissions. Accordingly, comments 440 may be displayed with associated controls to approve 445 or disapprove 450 each comment.

If a comment collection or “queue” is enabled, a collection deck 460 may also be displayed. For example, comments that have been placed on “hold”, tagged as spam, or even approved, may be placed in collection deck 460 for later posting by selecting the associated post control 465.

In some cases, collection deck 460 may be used to display the results of an external query or live search. A live search may be an automatic, continuous query or dynamic query of an internal or external source. For example, a live search may be a continuous search of sources identified in external queries. Photos or other content may be continuously or periodically retrieved from the external queries and presented in approval deck 460 for selection and approval. A search box (not shown) may also be provided to augment the external queries with additional searches.

A live search may repeatedly conduct the same query (e.g., “pull” model), or it may comprise an open connection for receiving results (e.g., “push” model).

In some cases, a second collection deck may be provided in parallel with collection deck 460, to display the results of the live search.

Various additional known multimedia content editing and content management features may also be provided, as will be appreciated by those skilled in the art.

Likewise, it will be appreciated that a plurality of users may have access to a user interface 400 for managing and editing the same data items. Different users may have differing degrees of access to manage and edit the data items. For example, some users may be limited to providing input data for new data items, and may be prevented from later editing or deleting data items. Other users may only be enabled to moderate comments. Still other users may have full permission to provide input data for new data items, edit existing data items and moderate comments.

Referring now to FIG. 5, there is shown an exemplary content input process flow, which may be carried out by content input module 216. Content input process flow 500 begins by receiving input data. The input data may be entered using an interface, such as interface 400, and associated with a data collection at 510. The input data may be original input data authored by a known user using an writer or client device, input data retrieved from an external query, or a comment received from an end user, a server, etc. The writer device may be a mobile communication device, a desktop or laptop computer, or other suitable computing device. The input data can be associated with a particular data collection (e.g., according to the URL, ID, etc.) used to submit the input data. In particular, the submission URL may contain a unique identifier associated with the data collection. Alternatively, content input module 216 may associate the input data with the data collection if the input data was retrieved by dynamic publishing server 210 using an external query.

The input data may be processed at 520 by content input module 216 to generate a data item for storage in database 212. For example, content input module 216 may sanitize text, recompress images, generate icon or thumbnail representations of links or images, and the like.

Content input module 216 may also generate or update a content index for identifying the data item. The content index may be an incrementally-numbered index value, a character string, a timestamp or any other suitable index value, as described herein. In some cases, the content index may be managed as described in as described in U.S. Provisional Application No. 61/449,540, filed Mar. 4, 2011, the entire content of which is incorporated by reference herein.

Once the content index has been generated or updated, the data item and content index are stored in database 212 in association with the data collection.

Referring now to FIG. 6, there is shown an exemplary update process flow, which may be carried out by content management module 220. Update process flow 600 may be performed asynchronously from the generation of data items and publishing of the data items. In particular, process flow 600 may be performed periodically at predetermined intervals, for example by dynamic publishing server 210. In some cases, process flow 600 may be performed substantially continuously.

Content management module 220 may maintain a record of the current state of each data item associated with one or more data collections. Accordingly, process flow 600 may be performed independently for each data collection managed by dynamic publishing server 210. There may be more than one content management module 220 operating on each dynamic publishing server 210, each associated with one or more data collections.

At 610, a content database, such as database 212 is polled or queried to determine if data items associated with a particular data collection have been modified since the last poll or query was performed. Modifications may comprise the addition, deletion or change (e.g., editing) of a data item. If there are no modifications to the data items, content management module 220 may take no other action and wait a predetermined period before another query is generated.

If modifications to the one or more data items have occurred, content management module 220 identifies the modified data items at 630, and generates or regenerates a modification representation associated with the data collection at 640. In some cases, the modification representation may be a delta or “diff” identifying changes relative to a previous version. In other cases, the modification representation may comprise the entirety or a substantial portion of the added, deleted or changed data items. In general, the modification representation is a data structure suitable for instructing a device with a previous version of the data collection to update its local version of the data items to a current state or representation.

In some embodiments, the modification representation may be provided as a data item comprising executable instructions (e.g., JavaScript) to update one or more other data items in the relevant data collection.

In some other embodiments, the modification representation may be provided as a replacement data collection.

Any additions, changes or deletions in the data collection may be marked-up or highlighted, as desired.

Content management module 220 may also generate an update indication, which can be used to notify client devices that modifications have occurred. The update indication may be a unique identifier, such as a timestamp. In some cases, the update indication may comprise the modification representation itself.

At 660, content management module 220 generates one or more files corresponding to the update indication and/or the modification representation. The files can be published to a publication server, such as storage system 150 or CDN 160. In particular, the files associated with a particular data collection can be published at the one or more publication targets that are associated with the data collection and its corresponding publication object.

The modification representation files may be formatted, for example, according to the JavaScript Object Notation (JSON) data interchange format, although other suitable formats (e.g., XML) may also be used.

To generate a complete copy of a data collection at a client device, the data items can be retrieved and assembled in a desired order. In some cases, the publication object may also comprise one or more code objects for assembling and encapsulating the data collection. For example, a code object may be an HTML web page comprising JavaScript code for retrieving the one or more data items associated with a data collection, and periodically retrieving modification representations to update the data collection. The code object may be generated using a template object and thus be formatted in a style corresponding to the template object. In one example, the code object may comprise HTML and JavaScript configured to employ JSONP (JSON with padding) when retrieving data item and modification representation files, although other suitable approaches may also be used.

In some cases, files associated with a publication object can be stored on a storage system and a proxy server may be used in combination with AJAX techniques to deliver content to end users. The proxy server may be, in some cases, a server associated with the external publisher. Accordingly, it may be necessary to account for some cross-domain limitations associated with JavaScript or Flash.

Separation of functionality between content input module 216 and content management module 220 can serve to de-link the input process from the publishing or transmitting process, thus allowing for scalable delivery and facilitating backup and failover methods.

For example, content input module 216 can store newly added data items or modification representation files in two or more redundant databases 212, with a first primary database and one or more secondary, failover databases. In the event that a database fails, dynamic publishing server 210 can substantially immediately switch to a failover database without loss of database consistency or interruption of service. Once the failed database is restored, it can be synchronized with an in-service database and brought back into service.

Similarly, by transmitting files to storage system 150 or CDN 160, which can have multiple redundancy built-in, content management module 220 can ensure that no interruptions in service occur in the event of a hardware or network failure.

In many cases, it may be desirable for a content provider to generate and manage content, such as a data collection comprising data items, and also to have the data collection be available for publication and dissemination via multiple publication targets.

In some cases, the provider of the data collection may wish to add, change, delete or otherwise modify the data items that form the data collection, even after the data collection has been published. For example, if the data collection relates to a live event (e.g., an ongoing news story), there may be a need to update the data collection with new data items, or modify existing data items on an ongoing basis.

Individually updating a large number of publication targets would, in many cases, be unwieldy and inconvenient. However, by using data collections, a content provider can continue to add, change or delete data items without the need to individually update multiple publication objects.

As one example, there may be a live blog dedicated to a particular news topic. A live blog can be a publication object (e.g., a web page) that automatically provides updated content in real-time as new entries are generated or posted. The updates may be done seamlessly from the client perspective, such that the user may not be required to manually refresh the web page to see the updated content. The live blog may publish a publication object associated with a data collection, where the data collection comprises data items generated by the live blog writer or provider.

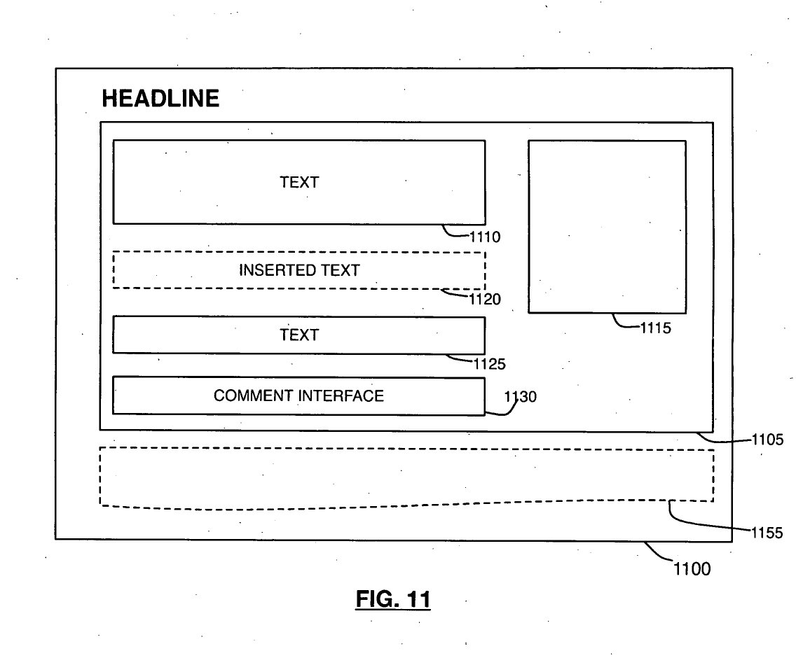

A live blog may be contrasted with an article with real-time updates, described herein with reference to FIG. 11.

In some cases, the live blog provider may wish to augment the data collection with additional data items. For example, the data collection may comprise live updates regarding an unfolding news story.

Referring now to FIG. 7, there is shown an exemplary template generation process flow, which may be carried out by template module 218. The template generation process flow may be carried out with each page request, at predetermined intervals, manually upon request by an administrator, or omitted entirely.

At 705, a page request for a code object associated with a publication object is received. For example, the page request may be passed back by CDN 160 in response to an end user client request. In some cases, the request may originate directly from an end user or from a local server or process.

At 710, template module 218 retrieves one or more template objects associated with the requested publication object from database 212: Generating the page with the available template object ensures that the requested code object can be delivered, without any delays imposed by the template retrieval and re-generation process.

Once the page has been generated, template module 218 may determine if a newer template object should be retrieved or generated at 720. For example, template module 218 may examine a timestamp or expiry time associated with the retrieved template object.

If it is determined that a newer template object should be retrieved, template module may, optionally, spawn a template retrieval thread at 735. The decision to spawn a new thread may depend on whether an existing template request is pending, which can be determined at 725. Alternatively, template module can continue the original thread.

If a template retrieval thread has been spawned at 735, template module 740 can request a new template object (e.g., page) from a template server, such as a third party website. The template page provided by the template server may be a preconfigured “dummy” page hosted by the third party website, which may contain headers, footers, layout information and other ancillary content. In some cases, the provided template page may contain a placeholder or content marker indicating where a publication object (e.g., comprising data items in a data collection) can be inserted. In some cases, the provided template page may not contain any primary content. The content marker may be a predetermined text marker (e.g., “—INSERT CONTENT HERE—”), a token or a preconfigured HTML tag, ID or class. In still other cases, the provided template page may contain existing content that can be discarded.

At 745, the template page may be received and template module 218 may determine if a content marker is present in the template page at 750. If a content marker is present, the template page may be used to update the current template object to use the new template object, and stored in database 212, at 755. In some cases, template module 218 may discard the received template page, for example, if an error has occurred.

In some cases, such as when a preconfigured template page is not provided by the template source, a template object may need to be manually generated or edited by an administrator. In such cases, template module 218 may reschedule template retrieval for a later time. Optionally, template module 218 may generate and transmit a message to an administrator that manual intervention is required, either to identify a content marker or to otherwise prepare the template object.

Template generation process 700 may also be performed periodically at predetermined intervals or on-demand based on some other event, such as a manual template update request.

Referring now to FIG. 8, there is shown an exemplary display process flow, which may be carried out by a client device to display a publication object and its associated data collection. The client device may be a mobile communication device, a desktop or laptop computer, or other suitable computing device. In particular, display process 800 may be performed by a client program, such as a web browser or other program code, such as a mobile device application.

At 805, the client program requests the publication object from a publication server, such as dynamic publishing server 210, storage system 150 or CDN 160. A response to the initial request may return simply a code object associated with the publication object at 810.

Once the code object has been received, the client may begin rendering the presentation display.

As noted, the code object may be an HTML document, which can contain or reference program code for assembling one or more data items associated with the data collection of the publication object.

When the client program first requests the publication object, a selection of data items associated with its data collection may be sent. The selection of the data items that is sent may be considered an initial representation of the data items. For example, the initial representation may simply comprise the current form of all data items associated with the data collection. In some cases, the initial representation may comprise all data items dated within a recent interval period (e.g., all data items received or generated in the past 30 minutes). Likewise, the initial representation may be paginated, with only more recent data items appearing directly in the initial representation, whereas older data items may be linked or may be revealed progressively as a user scrolls through a list of data items.

At 815, the client may request an indication of when the most recent update or modification to the data collection occurred. The indication may be a unique identifier, which can be sequentially numbered so that the client device can determine when an update has occurred. For example, the indication may comprise a timestamp identifying the time of the last update.

At 820, the client requests the initial representation of the data collection. Generally, the initial representation will contain up-to-date data items. Accordingly, the initial indication may be used simply as a reference so that later updates can be identified.

Once data items associated with the data collection begin to be received, the client may, at 825, render the data items in the presentation or output display in the appropriate order.

If the data collection is a live event or is being updated, the code object may indicate that the client should periodically poll for an update indication. Accordingly, at 830, the client may be instructed to wait a predetermined interval. Upon expiry of the interval, the client may request the update indication again at 835.

The client may determine if an update indication exists at 840. If an update indication exists, the client may return to 815 to request a modification representation. If there is no update indication (e.g., because the data collection has not been updated), the client may return to 830 to wait the predetermined interval before attempting to request an update indication again.

In some cases, certain steps of display process 800 may be omitted. For example, if a request is made through an API, display step 825 may be omitted.

Thus to generate the presentation display containing the data collection and its respective data items, the client retrieves a code object, an indication and one or more corresponding data item files. The client also periodically polls for an update indication. If an update indication exists, the client can retrieve a modification representation to generate, at the client, a current representation of the data collection.

In some cases, each modification representation may represent all additions, deletions and changes since the last update indication was generated. However, in other cases, each modification representation may represent only those additions, deletions and changes that have occurred within a recent predetermined time interval. Accordingly, the current representation of the data collection that is maintained at a client device may not fully reflect the actual data collection maintained by dynamic publishing server 210. This may be an acceptable trade-off in some cases, such as a fast-changing live event.

Providing a large number of data items in an output display may be unwieldy and inefficient. Accordingly, in some cases, it may be desirable to limit the number of data items that are displayed at once. For example, the data collection may be paginated or subdivided into groups or “pages” of a predetermined size. Each of the groups or pages may have a URL associated with it, which when selected can result in the retrieval of the relevant group of data items.

Pagination may be displayed in a different manner, depending on the state or type of publication object. For example, links to the groups of data items may be displayed in reverse chronological order when the publication object is live and displayed in forward chronological order when the publication object is not live.

In general, the number of data items in a group can be kept within a predetermined limit of data items. However, in some cases a hard limit may not be desirable. For example, if a most recent group of data items exceeds the predetermined limit, it may not be desirable to perform pagination immediately, as this may result in a group with very few data items, which would provide little context for an end user. Accordingly, pagination may be delayed in some cases until the number of data items displayed in the current representation exceeds the predetermined limit of data items by a predetermined threshold (e.g., 20%).

Use of the client in this manner relieves dynamic publishing server 210, storage system 150 and CDN 160 of the additional burden of regenerating a complete page for each new data item that is added, deleted or changed in the data collection. Each added, deleted or changed data item requires only a small amount of resources to provide, as it requires only small, static files to be used (e.g., the update indication and the modification representation), which can be cached and made available at a common location (e.g., URL) so that all watchers can poll the common location periodically. Likewise, a “push” notification is not necessary, as the client is instructed to periodically determine if there is new content to be retrieved.

There may be a relatively small increase in bandwidth relative to a push-based system, due to client requests for new content index files. However, this relatively small burden can be easily handled by CDN 160 or storage system 150 and provides the benefit of significantly reducing resource requirements for dynamic publishing server 210 and even storage system 150 (where CDN 160 is used).

For the purposes of illustration, a number of exemplary uses of the described embodiments will now be provided.

In some cases, it may be desirable for the publisher of an online publication, such as a live blog, to be able to provide content in real-time, while maintaining the ability to scale to a large number of clients. The live blog may provide a collection of real-time live blog entries, which may be in the form of text, images, audio or video. Accordingly, each entry may be a data item, in a data collection created for the live blog.

In order to scalably publish and update the live blog, the live blog entries (e.g., data items) may be entered into a database and associated with a data collection of the live blog.

The database may be periodically polled by a content management module, to identify at least one modification of the live blog entries, including additions, changes or deletions of the entries in the live blog.

If a modification of one or more live blog entries is identified, the content management module can generate and store a modification representation of the changes. The modification representation may be information that can be used to reproduce changes to the live blog entries based on a previous version. In addition to the modification representation, the content management module may also generate an indication of the changes, which may be a file with a timestamp, signifying the last known update to the live blog.

Each of the live blog entries, the modification representations and the indications can be published on a storage system, such as Amazon S3. A CDN may be also be used to distribute the content stored on the storage system.

Accordingly, a client can receive content directly from the CDN (or in some cases from the storage system) without directly communicating with the live blog publishing server, although this may be permitted in some cases.

From the client perspective, the client may receive an initial representation of the live blog, comprising each of the live blog entries to date. If there are a large number of live blog entries, the client may receive only a number of most recent entries, with the remainder being “paginated”. In particular, pagination may allow older entries to be retrieved when a user clicks a link, or scrolls beyond a predetermined point, alleviating the need for the client to retrieve all entries in the live blog initially.

The client can display the initial representation, comprising the live blog entries. The client may also be configured, based on code embedded in the live blog, to periodically request an update indication, such as the indication generated by the publishing server. If the update indication is available, and indicates that the live blog has changed such that the client's version is no longer up-to-date, the client may request the modification representation currently available. Based on the modification representation, the client may update, its own initial representation (or subsequent representations created with previous modification representations). Accordingly, the representation of the live blog at the client can be updated in real-time. It will be appreciated that the client need not interact directly with the publishing server. The publishing server can publish files to a storage system and/or CDN. Conversely, the client need only interact with the CDN and/or storage system. In some cases, the client may be able to communicate directly with the publishing server.

In some cases, a content provider may wish to provide a consistent presentation style, or to adopt the presentation style of a third-party. For this purpose, templates may be used. It may be desirable for the templates to be periodically updated, to ensure that content generated by publishing server is provided in a current presentation style.

For example, a live blog for a news organization may be presented using a template associated with the main website of the news organization. The news organization may periodically, even frequently, update the presentation of the main website. Accordingly, the live blog template may need to be updated periodically to reflect these changes.

When publishing the live blog, a template module may determine if a current template exists. If the current template exists, the live blog may be published using the current template. In some cases, an expiry time of the current template may be checked, and if it is determined that the current template should be updated, a template update process can be initiated. In some other cases, there may be an offline process to perform the template update process.

If the template update process is initiated, it may comprise retrieving a predetermined page from the main website of the news organization. The predetermined page may be a “dummy” page, with a content placeholder or an empty area of the page reserved for the live blog content. In some cases, the “dummy page” may be a regular content page. Accordingly, in some cases, it may be necessary for an administrator to manually edit the “dummy” page to generate the updated template.

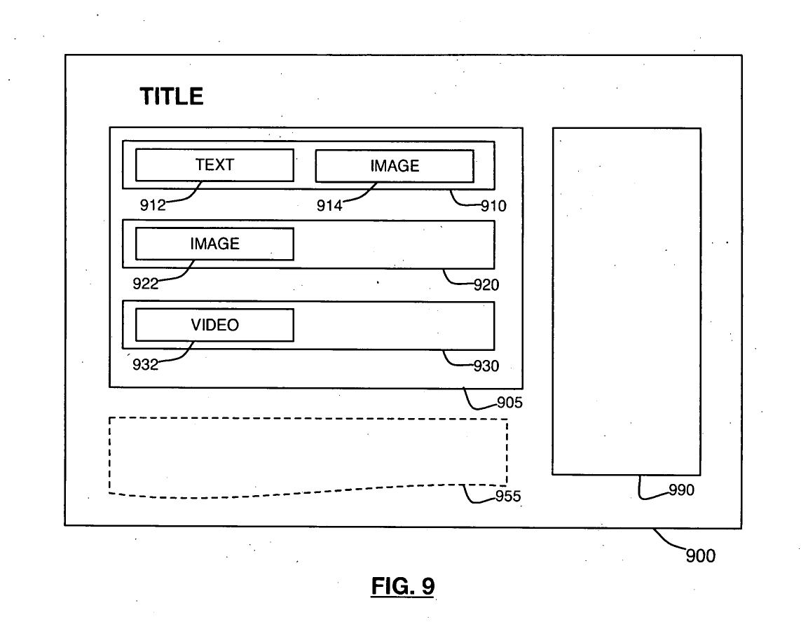

Referring now to FIG. 9, there is shown an exemplary publication object 900.

Publication object 900 may be a web page comprising a data collection 905 and other content 990. Other content 990 may be a navigation menu, advertisements, static content or any other suitable content.

As shown, publication object 900 comprises a data collection 905. Data collection 905 comprises data items 910, 920 and 930. Data item 910 comprises text content 912 and image content 914. Similarly, data item 920 comprises image content 922, and data item 930 comprises video content 932. Although not shown, data collection 905 could also comprise data items, for example, with audio content or computer-executable instructions. The computer-executable instructions may not be visible when the publication object 900 is displayed by a client.

As described herein, in the context of dynamic content, the data items 910, 920 and 930 in data collection 905 may be modified in real time. In particular, new data items may be added, and the existing data items in the data collection may be changed or deleted.

In one example, data collection 905 may be a block of HTML content, for example enclosed in a DIV tag. Data items 910, 920 and 930 may be identified with indices, tokens, tags or other suitable identifiers, as described herein.

Optionally, there may be one or more additional data collections 955. In some cases, the additional data collections may be displayed separately. In some other cases, the additional data collections may be integrated with data collection 905.

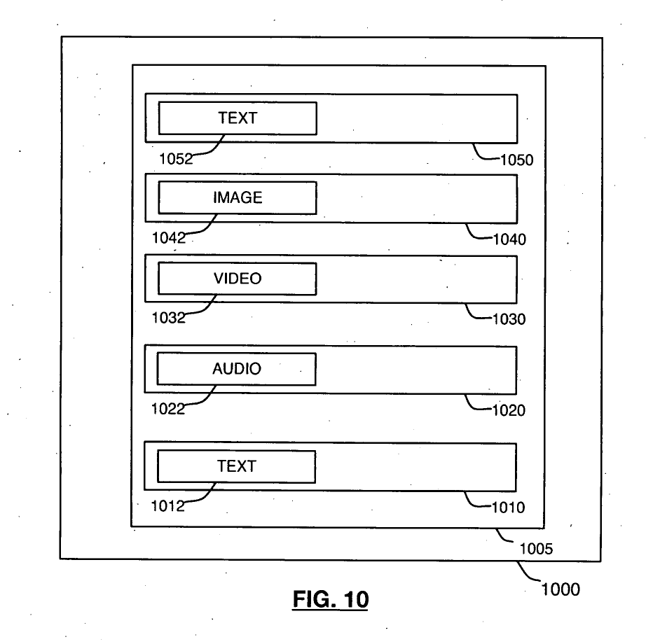

Referring now to FIG. 10, there is shown an exemplary live blog publication object.

Data item 1010 comprises a text item 1012 written by a writer. Data item 1020 comprises an audio comment 1022, which may be automatically generated, for example, based on data received from a VOIP interface. Data item 1030 comprises a video 1032. Data item 1040 comprises an image 1042 posted by the writer of the live blog. Data item 1050 may comprise a user comment 1052 posted to the live blog using a comment entry form (not shown). The user comment may appear in the live blog stream immediately upon submission. Alternatively, the user comment may be held for moderation as described herein.

In the exemplary embodiment, each of data items 1010 to 1050 may be separate live blog posts. For example, each of the data items may have a date or timestamp associated therewith. However, in some cases, some or all of the data items 1010 to 1050 may appear to be part of the same live blog post.

Referring now to FIG. 11, there is shown an exemplary publication object comprising an article portion and a live blog portion. The article portion may be an article with real-time updates, as described in U.S. Provisional Application No. 61/449,540, filed Mar. 4, 2011, the entire content of which is hereby incorporated by reference.

Publication object 1100 comprises a first data collection 1105 and a second data collection 1155. In some embodiments, the first data collection 1105 may comprise the second data collection 1155, or vice versa.

First data collection comprises data items including text blocks 1110 and 1130, an inserted text block 1120 and a user comment interface 1130. First data collection also comprises an image data collection 1115.

Text blocks 1110, 1120 and 1130 may be, for example, HTML content comprising text content and appropriate mark-up tags.

Image data collection 1115 may be a data collection that comprises an image data item and a caption data item.

Each data item in first data collection may be modified, added or deleted in real-time as described herein. In particular, inserted text block 1120 may be a data item that is added to the first data collection 1105 in real-time.

Second data collection 1155 may be a data collection for a live blog, similar to data collection 1005.

It will be appreciated that various embodiments may comprise one or more special purpose or general purpose computers or servers, each of which may include, but are not limited to, one or more processors, memories, storage devices, input/output devices and network interfaces. Likewise, the terms ‘computer’ and ‘server’ may be interchangeable in accordance with the above description. Although embodiments have been described as separate components, it will be understood that various components and modules could be combined into a single module, computer or server, or implemented across multiple modules, computers or servers all connected via a communications medium such as the Internet. Likewise, it will be understood that functionality described herein as being provided by a specific component or module may also be provided by another component or module without departing from the scope of these embodiments.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Various modifications and variations may be made to these exemplary embodiments without departing from the spirit and scope of the invention, which is limited only by the appended claims.

We claim:

1. A method of managing online content wherein the content comprises a data collection identified in a database having one or more data items associated therewith, the method comprising:
periodically polling the database to identify at least one modification of the one or more data items;
if the polling identifies the at least one modification, generating, using a processor, a modification representation associated with the data collection, the modification representation identifying the at least one modification of the one or more data items; and
storing the modification representation.

2. The method of claim 1, wherein the one or more data items are also associated with a second data collection, further comprising:
if the polling identifies the at least one modification, generating, using the processor, a second modification representation associated with the second data collection, the second modification representation identifying the at least one modification of the one or more data items; and
storing the second modification representation.

3. The method of claim 1, further comprising, if the polling identifies the at least one modification, generating at least one indication that the at least one modification has occurred.

4. The method of claim 2, further comprising transmitting the at least one indication to a server.

5. The method of claim 2, wherein the at least one indication is a file comprising a unique identifier.

6. The method of claim 5, wherein the unique identifier is a timestamp.

7. The method of claim 1, wherein the modification representation identifies only modifications that occurred within a predetermined interval window.

8. The method of claim 1, wherein the modification representation comprises data for recreating the at least one modification.

9. The method of claim 1, wherein the at least one modification comprises an addition of a data item to the one or more data items.

10. The method of claim 1, wherein the at least one modification comprises a deletion of a data item from the one or more data items.

11. The method of claim 1, wherein the at least one modification comprises a change to a data item in the one or more data items.

12. The method of claim 1, wherein storing the modification representation comprises transmitting the modification representation to a server.

13. The method of claim 1, further comprising, prior to generating the modification representation:
receiving input data;
processing the input data to generate the one or more data items; and
associating the one or more data items with the data collection in a database.

14. The method of claim 13, further comprising transmitting an initial representation of the one or more data items to a server.

15. The method of claim 13, further comprising associating a template with the data collection.

16. The method of claim 1, wherein the polling occurs asynchronously to the generating the modification representation.

17. The method of claim 1, wherein the polling occurs asynchronously to the storing the modification representation.

18. The method of claim 1, wherein the server is part of a content distribution network.

19. A method of updating one or more data items at a client device, the one or more data items associated with content for an online publication wherein the content comprises a data collection identified in a database, the method comprising:
receiving an initial representation of the one or more data items from a server;
displaying an output based on the initial representation;
receiving a modification representation, the modification representation identifying at least one modification of the one or more data items;
generating, using a processor of the client device, a current representation of the one or more data items based on the initial representation and the modification representation; and
updating the output based on the current representation.

20. The method of claim 19, further comprising, prior to receiving the modification representation, periodically polling for an indication that the at least one modification has occurred and, if the indication indicates that the at least one modification has occurred, then receiving the modification representation.

21. The method of claim 19, wherein the modification representation comprises data for recreating the at least one modification.

22. The method of claim 19, wherein the at least one modification comprises an addition of a data item to the one or more data items.

23. The method of claim 19, wherein the at least one modification comprises a deletion of a data item from the one or more data items.

24. The method of claim 19, wherein the at least one modification comprises a change to a data item in the one or more data items.

25. The method of claim 19, wherein the initial representation comprises computer-executable instructions for causing the processor to perform the periodic polling and the receiving the modification representation.

26. The method of claim 19, further comprising, if a number of the data items to be displayed in the current representation exceeds a predetermined limit of data items, paginating the current representation.

27. The method of claim 26, wherein paginating the current representation comprises subdividing the one or more data items into two or more groups of data items and displaying only a most recent group of data items, and wherein each of the groups is sized according to the predetermined limit of data items.

28. The method of claim 26, wherein each of the groups has a unique URL.

29. The method of claim 26, wherein the URLs for each of two or more groups of data items are displayed in reverse chronological order when live and displayed in forward chronological order when not live.

30. The method of claim 26, wherein the paginating is delayed until the number of data items displayed in the current representation exceeds the predetermined limit of data items by a predetermined threshold.

31. The method of claim 26, wherein the predetermined threshold is 20%.

32. The method of claim 19, further comprising, prior to displaying the output, receiving a template from a template server, wherein the initial representation and the current representation are generated based also on the template.

33. The method of claim 32, wherein the template is associated with the data collection in the database.

34. The method of claim 32, wherein the template comprises a content marker, further comprising identifying a location of the content marker in the template, and wherein the current representation is generated by modifying the template to display the one or more data items substantially at the location of the content marker.

35. A method of generating content in response to a client request, the content comprising a one or more data items associated with a data collection, the method comprising:
determining if a current template associated with the data collection exists;
if the current template exists, generating an initial representation of the data collection based on the template;
determining if the current template should be updated; and
if the current template should be updated, initiating a template update comprising:
requesting a new template from a template server;
verifying the new template; and
if the verifying is successful, updating the current template based on the new template.

36. The method of claim 35, wherein the template update is initiated in a new thread or process.

37. The method of claim 35, wherein the verifying comprises identifying a content marker in the new template.

38. A system for scalable publishing of online content, the system comprising:
a database, the database for identifying a data collection having one or more data items associated therewith;
a publishing server, the publishing server configured to identify modifications to the data collection;
a storage system for storing the data collection;
a content management module, the content management module configured to determine that the modifications to the data collection have been identified and to transmit the modifications to the data collection to the storage system; and
a content distribution network for caching and delivering the data collection.

39. A system for scalable publishing of online content, the system comprising:
a database, the database for identifying a data collection having one or more data items associated therewith;
a publishing server;
a storage system;
a content management module, the content management module configured to:
periodically poll the database to identify at least one modification of the one or more data items;
if the polling identifies the at least one modification, generate a modification representation associated with the data collection, the modification representation identifying the at least one modification of the one, or more data items; and
transmit an indication of the modification representation to the storage system; and
a content distribution network for caching and delivering the data collection stored at the storage system.

40. A method of dynamic templating for online content wherein the content comprises a data collection identified in a database having one or more data items associated therewith, the method comprising:
determining that a current template object is to be updated;
requesting a new template object from a third-party server;
receiving the new template object from the third-party server;
processing, using a processor, the new template object to determine a content location in the new template object;
updating the current template object based on the new template object after processing; and
generating the online content using the data collection and the current template object as updated.

41. A method of publishing online content wherein the content comprises a data collection identified in a database having one or more data items associated therewith, the method comprising:
storing a list of one or more publication targets;
receiving a selection of publication targets from the one or more publication targets;
determining one or more template objects associated with the selection of publication targets;
generating a publication object, based on the data collection
for each of the selection of publication targets, formatting the publication object based on the associated template object and transmitting the publication object to a location associated with a respective publication target.
